(19) United States
(12) Patent Application Publication
(10) Pub. No.: US 2026/0174104 A1
(43) Pub. Date: Jun. 25, 2026

(54) PROCESS FOR PREPARING RAW FISH TISSUE ANOLOGUE

(71) Applicant: Conopco, Inc., d/b/a UNILEVER, Hoboken, NJ (US)

(72) Inventors: Lucas BOZZO VAN DER HEIJDEN, Wageningen (NL); Sophie VAN NIEUWENHUIZEN, Wageningen (NL); Marco SANTAGIULIANA, Wageningen (NL)

(73) Assignee: Conopco, Inc., d/b/a UNILEVER, Hoboken, NJ (US)

(21) Appl. No.: 19/124,932

(22) PCT Filed: Nov. 1, 2023
(86) PCT No.: PCT/EP2023/080479

§ 371 Date: Apr. 28, 2025

(30) Foreign Application Priority Data
Nov. 11, 2022 (EP) 22206963.5

(51) Int. Cl. A23J 3/22; A23J 3/14; A23J 3/16; A23L 29/212; A23L 29/238; A23L 29/256; A23L 29/269

(52) U.S. Cl. CPC A23J 3/227; A23J 3/14; A23J 3/16; A23L 29/212; A23L 29/238; A23L 29/256; A23L 29/27

(57) ABSTRACT

An improved process to prepare a raw fish tissue analogue and an improved raw fish tissue analogue substantially free of konjac mannan gum.

The present invention relates to a process for preparing raw fish tissue analogue and a raw fish tissue analogue which is substantially free of konjac mannan gum, preferably substantially free of animal proteins.

There is an increasing demand for raw seafood, in particular slices of raw fish like salmon and tuna often eaten as sashimi or sushi. Farmed salmon is said to provide a way to offer much needed source of protein. On the other hand, salmon farms require massive amounts of fish protein, pesticides and antibiotics. In addition, some studies warn that a single meal per month of farmed Atlantic salmon can expose consumers to contaminant levels exceeding standards from the World Health Organization. Many species of tuna face extinction.

While the number of meat analogue products in European supermarkets has increased sharply in the past few years, there are very few raw fish tissue analogue products on the market like raw slices of salmon. There have been some publications on the preparation of salmon analogue products on lab scale, it seems, however, that these are unsuitable to upscale for large scale industrial processing or are simply not producing products that consumers appreciate. Some salmon analogues have an undesirable texture: some are like eating hard pieces of gel, others have a soggy-chewy texture. Other products rely on titanium dioxide which provides an unnatural appearance. Many are based on konjac mannan gum which is not allowed in some countries. This limits the commercial value as it complicates the roll-out on a global scale.

### Additional Information

The characteristic appearance of slices of real fish is a layered appearance: alternating layers of muscle tissue and connective tissue. In raw real salmon the layers these are typically orange respectively white coloured. Algama WO2021/170856 claims to disclose a process to produce a raw salmon analogue but without the layered appearance.

Nestle's WO 2022/038244 discloses a process to prepare a salmon analogue comprising alternating orange and white layers. The layering of the subsequent orange layers is carried out by pouring a subsequent layer of liquid gel composition on the previous layer which is still hot and liquid. The intermediate white layer is made by sprinkling powdered insoluble fibers on the hot surface of the orange layer followed by spraying with calcium carbonate solution.

CN 114 931 210 A discloses a salmon analogue based on gellan.CN114259040A discloses a process to prepare a salmon analogue by preparing two different slurries based on 10 wt % starch acetate: one colored orange with beta carotene (A) and one colored white with titanium dioxide (B). A first layer A is prepared by heating and cooling slurry A to form the gel. Then, slurry B is heated and poured on top of A and allowed to gel. This is repeated to stack five layers. The consecutive cooling steps energy intensive and introduce a possible food safety hazard as the intermediate product is neither chilled nor hot enough for a prolonged period of time to prevent microbial growth. Together with the defoaming step, the repeated cooling results in long processing times. Working with titanium dioxide—a known group 2 carcinogen—is considered a safety hazard. Moreover, said process relies on relatively high levels of starch acetate, a chemically modified starch. The use of chemically modified starch is undesirable for many consumers. The product is limited to relatively low levels of protein of 2.5% as 5 wt % of protein was found to be unsuccessful. Higher amounts resulted in a product which was too soft without the desired elasticity and mouthfeel. Unfortunately, also these products rely on konjac mannan gum. Thus, there remains a need for an improved process to prepare a raw fish tissue analogue which can be more easily applied on industrial production lines and improved raw fish tissue analogue products such salmon and tuna and does not rely on konjac mannan gum.

### SUMMARY OF THE INVENTION

One of the main challenges of providing a raw fish tissue analogue is to have a mouthfeel closely resembling that of raw fish which is clearly different from cooked fish or cooked meat. Surprisingly, one the advantages of present invention is that the raw fish tissue analogue unmistakably resembles that that of raw fish and not cooked fish without the need to use konjac mannan gum.

The present invention provides a process for preparing a raw fish tissue analogue which is substantially free of konjac mannan gum comprising the steps of
a) providing a slice of thermo-reversible gelled fish muscle tissue analogue composition M;
b) providing a slice of thermo-reversible gelled fish tissue connective analogue composition C; whereby preferably said gelled compositions M and C are visually distinct and preferably are substantially free of titanium dioxide, preferably said slices have been obtained by slicing respectively
   i. a body of the gelled tissue analogue composition M to form slices of said composition
   ii. a body of the gelled tissue analogue composition C to form slices of said composition
c) making a layered stack of slices whereby slices of the gelled compositions M and C are layered alternately to form a stack with a layered appearance.
d) fusing the alternating layers in the layered stack to each other by heating the layered stack to above the melting temperature of composition M and/or C followed by cooling the layered stack to below said melting temperature to form a stack of fused layers resulting in a body of raw fish tissue analogue.
e) optionally, slicing the stack of fused layers to form slices of raw fish tissue analogue whereby the slices have a layered appearance showing alternating layers of the gelled muscle tissue analogue composition M and the gelled connective tissue analogue composition C, preferably whereby the layered appearance shows at least one layer of the gelled connective tissue analogue composition C between two layers of the gelled muscle tissue analogue composition M; and
preferably whereby the raw fish tissue analogue is a raw salmon analogue or a raw tuna analogue.

The raw fish analogue is preferably a raw salmon analogue, preferably thermo-reversible salmon analogue.

The present invention provides a process for preparing a raw fish tissue analogue which is substantially free of konjac mannan gum comprising the steps of
a) providing a slice of thermo-reversible gelled fish muscle tissue analogue composition M;
b) providing a slice of thermo-reversible gelled fish tissue connective analogue composition C;
c) making a layered stack of slices whereby slices of the gelled compositions M and C are layered alternately to form a stack with a layered appearance.
d) fusing the alternating layers in the layered stack to each other by heating the layered stack to above the melting temperature of composition M and/or C followed by cooling the layered stack to below said melting temperature to form a stack of fused layers resulting in a body of raw fish tissue analogue.
e) optionally, slicing the stack of fused layers to form slices of raw fish tissue analogue whereby the slices have a layered appearance showing alternating layers of the gelled muscle tissue analogue composition M and the gelled connective tissue analogue composition C, whereby the layered appearance shows at least one layer of the gelled connective tissue analogue composition C between two layers of the gelled muscle tissue analogue composition M; and preferably whereby the raw fish tissue analogue is a raw salmon analogue or a raw tuna analogue, whereby the G′ at 20° C. of the gelled fish muscle tissue analogue composition is at least 5 000 Pa s, more preferably at least 10 000 Pa s, even more preferably at least 15 000 Pa s, even more preferably at least 20 000 Pa s, most preferably at least 25 000 Pa s.

The present invention provides a process for preparing a raw fish tissue analogue which is substantially free of konjac mannan gum comprising the steps of
a) providing a slice of thermo-reversible gelled fish muscle tissue analogue composition M;
b) providing a slice of thermo-reversible gelled fish tissue connective analogue composition C;
c) making a layered stack of slices whereby slices of the gelled compositions M and C are layered alternately to form a stack with a layered appearance.
d) fusing the alternating layers in the layered stack to each other by heating the layered stack to above the melting temperature of composition M and/or C followed by cooling the layered stack to below said melting temperature to form a stack of fused layers resulting in a body of raw fish tissue analogue.
e) optionally, slicing the stack of fused layers to form slices of raw fish tissue analogue whereby the slices have a layered appearance showing alternating layers of the gelled muscle tissue analogue composition M and the gelled connective tissue analogue composition C; whereby the layered appearance shows at least one layer of the gelled connective tissue analogue composition C between two layers of the gelled muscle tissue analogue composition M; and preferably whereby the raw fish tissue analogue is a raw salmon analogue or a raw tuna analogue,
whereby the raw fish tissue analogue comprises galactomannan gum and carrageenan gum whereby the w/w ratio between carrageenan gum and galactomannan gum is at least 1, preferably at least 1.2, more preferably at least 1.5, even more preferably at least 2.

The present invention provides a process for preparing a raw fish tissue analogue which is substantially free of konjac mannan gum comprising the steps of
a) providing a slice of thermo-reversible gelled fish muscle tissue analogue composition M;
b) providing a slice of thermo-reversible gelled fish tissue connective analogue composition C;
c) making a layered stack of slices whereby slices of the gelled compositions M and C are layered alternately to form a stack with a layered appearance.
d) fusing the alternating layers in the layered stack to each other by heating the layered stack to above the melting temperature of composition M and/or C followed by cooling the layered stack to below said melting temperature to form a stack of fused layers resulting in a body of raw fish tissue analogue.
e) optionally, slicing the stack of fused layers to form slices of raw fish tissue analogue whereby the slices have a layered appearance showing alternating layers of the gelled muscle tissue analogue composition M and the gelled connective tissue analogue composition C, whereby the layered appearance shows at least one layer of the gelled connective tissue analogue composition C between two layers of the gelled muscle tissue analogue composition M; and preferably whereby the raw fish tissue analogue is a raw salmon analogue or a raw tuna analogue,
whereby the raw fish tissue analogue comprises non-animal protein and liquid oil, whereby the combined amount of protein and liquid oil is at least 8 wt %, more preferably at least 11 wt %, even more preferably at least 13 w %, even more preferably of from 8 to 30 wt %, even more preferably 11 to 24 wt %, even more preferably 13 to 22 wt %.

The present invention provides a process for preparing a raw fish tissue analogue which is which is substantially free of konjac mannan gum comprising the steps of
a) providing a slice of thermo-reversible gelled fish muscle tissue analogue composition M;
b) providing a slice of thermo-reversible gelled fish tissue connective analogue composition C; whereby preferably said gelled compositions M and C are visually distinct and preferably are substantially free of titanium dioxide, preferably said slices have been obtained by slicing respectively
   i. a body of the gelled tissue analogue composition M to form slices of said composition
   ii. a body of the gelled tissue analogue composition C to form slices of said composition
c) making a layered stack of slices whereby slices of the gelled compositions M and C are layered alternately to form a stack with a layered appearance.
d) fusing the alternating layers in the layered stack to each other by heating the layered stack to above the melting temperature of composition M and/or C followed by cooling the layered stack to below said melting temperature to form a stack of fused layers resulting in a body of raw fish tissue analogue.
e) optionally, slicing the stack of fused layers to form slices of raw fish tissue analogue whereby the slices have a layered appearance showing alternating layers of the gelled muscle tissue analogue composition M and the gelled connective tissue analogue composition C, preferably whereby the layered appearance shows at least one layer of the gelled connective tissue analogue composition C between two layers of the gelled muscle tissue analogue composition M; and
preferably whereby the raw fish tissue analogue is a raw salmon analogue or a raw tuna analogue, whereby said raw fish tissue analogue comprises
i) 0.3 to 2 wt %, preferably 0.5 to 1.5 wt % of galactomannan gum;
ii) 2 to 5 wt %, preferably 2 to 3.5 wt % of kappa carrageenan gum;
iii) 0.05 to 1.0 wt %, preferably 0.1 to 0.5 wt % of xanthan gum;
iv) 5 to 10 wt %, preferably 6.0 to 7.5 wt % of non-animal protein, preferably legume protein, more preferably pea or soy protein, even more preferably pea protein, preferably added as a protein isolate;
v) preferably 3 to 20 wt %, more preferably 6 to 18 wt %, even more preferably 8 to 16 wt % of liquid oil,
preferably whereby the combined amount of protein and liquid oil is at least 8 wt %, more preferably at least 11 wt %, even more preferably at least 13 w %, even more preferably of from 8 to 30 wt %, even more preferably 11 to 24 wt %, even more preferably 13 to 22 wt %,
vi) colouring agent, preferably in an amount of at least 0.05 wt %, more preferably at least 0.1 wt %, even more preferably at least 0.5 wt %, preferably in an amount of 0.05 to 5 wt % of more preferably 0.1 to 3 wt %, even more preferably 0.5 to 2 wt %,
vii) flavouring agent, preferably in an amount of 0.1 to 5 wt % of flavouring agent, more preferably of 0.2 to 3 wt %, even more preferably 0.5 to 2 wt %;
viii) preferably 0.2 to 7 wt % of starch, preferably non-chemically modified starch, more preferably physically modified starch, even more preferably physically modified potato starch.

The present invention provides a raw fish tissue analogue which is substantially free of konjac mannan gum comprising alternating layers of
a) thermo-reversible gelled fish muscle tissue analogue composition M
b) thermo-reversible gelled fish tissue connective analogue composition C;
whereby the raw fish tissue analogue has a layered appearance showing alternating layers of the gelled muscle tissue analogue composition M and the gelled connective tissue analogue composition C, preferably whereby the layered appearance shows at least one layer of the gelled connective tissue analogue composition C between two layers of the gelled muscle tissue analogue composition M;
whereby preferably said gelled compositions M and C are visually distinct and preferably are substantially free of titanium dioxide;
preferably whereby the alternative layers have been fused to each other by heating a stack of alternating layers of M and C followed by cooling, and
preferably whereby the raw fish tissue analogue is thermo-reversible.
preferably obtainable by a process according to the invention.

The present invention provides a raw fish tissue analogue which is substantially free of konjac mannan gum comprising alternating layers of
a) thermo-reversible gelled fish muscle tissue analogue composition M
b) thermo-reversible gelled fish tissue connective analogue composition C;
whereby the raw fish tissue analogue has a layered appearance showing alternating layers of the gelled muscle tissue analogue composition M and the gelled connective tissue analogue composition C, preferably whereby the layered appearance shows at least one layer of the gelled connective tissue analogue composition C between two layers of the gelled muscle tissue analogue composition M;
whereby preferably said gelled compositions M and C are visually distinct and preferably are substantially free of titanium dioxide;
preferably whereby the alternative layers have been fused to each other by heating a stack of alternating layers of M and C followed by cooling, and
preferably whereby said raw fish tissue analogue is thermo-reversible,
preferably whereby said raw fish tissue analogue obtainable by a process according to the invention,
preferably whereby said raw fish tissue analogue comprises
i) 0.3 to 2 wt %, preferably 0.5 to 1.5 wt % of galactomannan gum;
ii) 2 to 5 wt %, preferably 2 to 3.5 wt % of kappa carrageenan gum;
iii) 0.05 to 1.0 wt %, preferably 0.1 to 0.5 wt % of xanthan gum;
iv) 5 to 10 wt %, preferably 6.0 to 7.5 wt % of non-animal protein, preferably legume protein, more preferably pea or soy protein, even more preferably pea protein, preferably added as a protein isolate;
v) preferably 3 to 20 wt %, more preferably 6 to 18 wt %, even more preferably 8 to 16 wt % of liquid oil,

Preferably whereby the combined amount of protein and liquid oil is at least 8 wt %, more preferably at least 11 wt %, even more preferably at least 13 w %, even more preferably of from 8 to 30 wt %, even more preferably 11 to 24 wt %, even more preferably 13 to 22 wt %,
vi) colouring agent, preferably in an amount of at least 0.05 wt %, more preferably at least 0.1 wt %, even more preferably at least 0.5 wt %, preferably in an amount of 0.05 to 5 wt % of more preferably 0.1 to 3 wt %, even more preferably 0.5 to 2 wt %,
vii) flavouring agent, preferably in an amount of 0.1 to 5 wt % of flavouring agent, more preferably of 0.2 to 3 wt %, even more preferably 0.5 to 2 wt %;
viii) preferably 0.2 to 7 wt % of starch, preferably non-chemically modified starch, more preferably physically modified starch, even more preferably physically modified potato starch.

The present invention provides a raw fish tissue analogue which is substantially free of konjac mannan gum comprising alternating layers of
a) thermo-reversible gelled fish muscle tissue analogue composition M
b) thermo-reversible gelled fish tissue connective analogue composition C;
whereby the raw fish tissue analogue has a layered appearance showing alternating layers of the gelled muscle tissue analogue composition M and the gelled connective tissue analogue composition C, preferably whereby the layered appearance shows at least one layer of the gelled connective tissue analogue composition C between two layers of the gelled muscle tissue analogue composition M;
whereby preferably said gelled compositions M and C are visually distinct and preferably are substantially free of titanium dioxide;
preferably whereby the alternative layers have been fused to each other by heating a stack of alternating layers of M and C followed by cooling, and
preferably whereby said raw fish tissue analogue is thermo-reversible,
preferably whereby said raw fish tissue analogue comprises
i) 0.3 to 2 wt %, preferably 0.5 to 1.5 wt % of galactomannan gum;
ii) 2 to 5 wt %, preferably 2 to 3.5 wt % of kappa carrageenan gum;
iii) 0.05 to 1.0 wt %, preferably 0.1 to 0.5 wt % of xanthan gum;
iv) 5 to 10 wt %, preferably 6.0 to 7.5 wt % of non-animal protein, preferably legume protein, more preferably pea or soy protein, even more preferably pea protein, preferably added as a protein isolate;
v) 6 to 18 wt %, even more preferably 8 to 16 wt % of liquid oil whereby the combined amount of protein and liquid oil is at least 11 wt %, even more preferably at least 13 w %, even more preferably 11 to 24 wt %, even more preferably 13 to 22 wt %;
vi) colouring agent, in an amount of at least 0.05 wt %, more preferably at least 0.1 wt %, even more preferably at least 0.5 wt %, preferably in an amount of 0.05 to 5 wt % of more preferably 0.1 to 3 wt %, even more preferably 0.5 to 2 wt %,
vii) flavouring agent, in an amount of 0.1 to 5 wt % of flavouring agent, more preferably of 0.2 to 3 wt %, even more preferably 0.5 to 2 wt %;
viii) preferably 0.2 to 7 wt % of physically modified starch, even more preferably physically modified potato starch,
preferably whereby said raw fish tissue analogue obtainable by a process according to the invention,

Whereby said raw fish tissue analogue is a raw salmon tissue analogue or a raw tuna tissue analogue.

Surprisingly the present invention provides a more robust process which is easier to apply in large scale industrial processing, e.g., suitable for preparing batches of hundreds of kilos. It is more robust than layering liquid gel composition on top of another layer of liquid gel which can easily mix. It does not rely e.g., 5 consecutive heating and cooling steps which are undesirable for microbial food safety reasons. It does not require complicated process management as often needed for preparing extrudates. It provides formulation flexibility as it allows the use of different gelling agents to provide the thermo-reversible gels without the need for konjac mannan gum. Although the applicants do not wish to be bound by theory it is hypothesized that the present invention provides a robust process which provides the skilled person with increased formulation flexibility to use relatively high amounts of protein and oil and still get the desirable mouthfeel without processing tissues like phase separation and foaming.

### DETAILED DESCRIPTION OF THE INVENTION

### Definitions

The term “animal protein” as used herein refers to protein from animals like mammals, fish and fowl including chicken, cows, pigs, sheep, goat, fish etc. It includes milk protein, egg protein. The term “non-animal” as used herein refers to a plant, algae, fungus, or microbe.

The term “raw fish analogue” as used herein refers to a food product resembling the respective real-raw fish product in appearance, mouthfeel, smell and taste whereby at least 80 wt % of all the protein is of non-animal origin. Examples include salmon and tuna. Preferably, the raw fish tissue analogue is a vegan raw fish analogue.

The term “vegan” as used herein refers a raw fish tissue analogue substantially free of protein of animal origin including but not limited to dairy protein, egg white. Preferably, a vegan raw fish tissue analogue is substantially free of animal protein and animal fat. Even more preferably a vegan raw fish tissue analogue comprises less than 0.1 wt % of ingredients derived from animals, more preferably less than 0.01 wt %, even more preferably a vegan raw fish tissue analogue is substantially free of ingredients derived from animals.

The term “substantially free” as used herein is understood to mean that such ingredients are not added as such for a specific functionality but can be present in trace amounts as part of a another ingredient.

The term “texturized protein” or TP as used herein refers to texturized non-animal particles, which are produced by cooking the starting materials in an extruder cooker and extruding them to form a texturized protein. These are usually cut into particles and dried to less than 15% or even less than 10 wt % moisture content and traded as such. The term TP refers to both TP from plant protein (TVP) and from other non-animal protein like fungal, algal and microbial protein unless otherwise indicated herein or clearly contradicted by the context.

The term “plant protein” as used herein refers to proteins derived from angiosperms and excludes proteins obtained from fungus, algae, seaweed and microbes.

The term “TVP” or “texturized vegetable protein” as used herein refers to TP based on plant protein.

The term “protein isolate” as used herein refers to material having at least 90 wt % of protein based on dry matter. Examples include soy protein isolate, pea protein isolate and potato protein isolate.

The term “protein concentrate” as used herein refers to material having at least 50 wt % of protein based on dry matter. Examples include soy protein concentrate, pea protein concentrate and potato protein concentrate.

The term “plant fibre” as used herein refers to indigestible fibre isolated from plants added to the raw fish tissue analogue as a separate ingredient. Non-limiting examples include psyllium fibre and potato fibre.

The term “gum” as used herein refers to indigestible polysaccharides which can form an aqueous gel after heating and cooling. Examples include kappa-carrageenan gum, galactomannan gum, xanthan gum.

The term “non-chemically modified starch” as used herein refers starch which has not been chemically modified. An example of chemically modified starch is starch acetate. The term “non-chemically modified starch” includes native starch and starch prepared by starch blending, physical and enzymatic modification methods. Physical modifications include ultrasound, hydrothermal (e.g., heat-moisture treatment and annealing), pre-gelatinization (e.g., drum drying, roll drying, spray cooking, and extrusion cooking), high-pressure (high hydrostatic pressure), and pulsed electric field treatments.

The term “thermo-reversible gel” as used herein refers to a gel which upon heating becomes liquid and upon cooling gels again. The term “thermo-reversible” in this respect is intended to refer to a product which melts when the consumer would heat the product to above the melting temperature of e.g. at least 70° C., preferably at least 80° C., more preferably at least 90° C. This excludes thermo-stable gels like agar gels or starch acetate gels which remain solid when heated.

The term “slice” as used herein has the usual meaning as used in the art of food products, It refers to the format, a thin, broad and flat piece, usually cut from a larger body like a slice of bread: The shortest dimension is considered the thickness or height of the slice, the longest dimension the length of the slice, and width the dimension perpendicular to the length of the slice. The length and width define the horizontal plane of the slice. The ratio of the width to the thickness is usually and preferably at least 3, more preferably at least 4, even more preferably at least 5. The ratio of the length to the thickness is usually and preferably at least 8, more preferably at least 20, even more preferably at least 30.

The term “visually distinct” as used herein refers to a color difference a human eye can see. Preferably this corresponds to a delta E of at least 3 as measured using dE76.

These and other aspects, features and advantages will become apparent to those of ordinary skill in the art from a reading of the following detailed description and the appended claims. For the avoidance of doubt, any feature of one aspect of the present invention may be utilised in any other aspect of the invention. Ratio's are weight/weight, unless indicated otherwise. Similarly, all percentages are weight/weight percentages by weight of the raw fish analogue, unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated. If a range is described as from 0% to y % or less than y %, said ingredient may be absent. The terms “a” and “an” and “the” and similar referents as used herein refer to both the singular and the plural, unless otherwise indicated herein or clearly contradicted by context.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps. The term “substantially free of ingredient x” is understood to mean that ingredient x is not present in an amount to have an effect although it can be present in trace amounts as part of another ingredient. The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiments disclosed, but that the extent of protection will include all embodiments falling within the scope of the appended claims when using the description and drawings to interpret said claims. For the purpose of determining the extent of protection, due account shall be taken of any element which is equivalent to an element specified in the claims.

### Process for Preparing a Raw Fish Tissue Analogue

The raw fish tissue analogue according to invention is designed to resemble real raw fish in appearance, taste, smell and mouthfeel but without the use of fish protein or konjac mannan gum. Preferably the raw fish tissue analogue is a vegan fish analogue, i.e., free from any animal protein. The raw fish tissue analogue according to invention is designed to be consumed without heating the product. Preferably the raw fish tissue analogue is thermo-reversible: it would melt when cooked and not resemble e.g., fish which has been cooked in a pan. The raw fish tissue analogue preferably comprises alternating layers of gelled fish muscle tissue analogue composition M respectively a gelled fish connective tissue analogue composition C.

The raw fish tissue analogue according to invention is substantially free of konjac mannan gum, more preferably free of konjac mannan gum.

The first step of the process according to the invention comprises providing slices of thermo-reversible gelled fish muscle tissue analogue composition M respectively thermo-reversible gelled fish connective tissue analogue composition C. The term “gelled fish muscle tissue analogue composition M” may be used interchangeably with the terms “gelled fish muscle tissue analogue composition”, “gelled fish muscle tissue analogue” and simply the term “composition M”. Similarly, term “gelled fish connective tissue analogue composition C” may be used interchangeably with the terms “gelled fish muscle tissue analogue composition”, “gelled fish muscle tissue analogue” and simply the term “composition C”. Similarly, the term “raw fish tissue analogue composition” may be used interchangeably with the term “raw fish tissue analogue”. First, the step of providing a slice for composition M will be described in more detail. The step of providing a slice for composition C is similar. A slice of composition M is preferably obtained from slicing it from a larger body of gelled fish muscle tissue analogue composition M. The body of gelled composition M is prepared by hydrating at least one hydrocolloid in sufficient amount of water, admixing any remaining ingredients to form a homogenous mixture, heating said mixture to above 60° C., cooling the heated mixture to below 40° C. to form a body of gelled composition M. Preferably said mixture comprises liquid oil in which case the mixing is at a sufficiently high shear to form an emulsion which shows no phase separation before the following step in the process. The body of gelled composition C is prepared in the same way, except that preferably the layers of composition M and C are visually distinct in the slice of the raw fish analogue.

A following step comprises making a layered stack of slices whereby slices of the gelled compositions M and C are layered alternately to form a stack with a layered appearance. Typically, the slices are layered whereby the horizontal plane of one slice is placed on the horizontal plane of the previous slice, like a stack of slices of bread. Seen from the side, the stack has a layered appearance with the thickness of the slices corresponding to the height of the layers. The slices may have each desired thickness and the thickness may vary between the slices of the same composition. In addition, the slices of composition M may have a different thickness from slices of composition C. Preferably the slices of composition M are thicker than composition C as this better represents the proportion between the layers of muscle tissue and connective tissue in real raw fish. The slices of the gelled compositions M and C may have thickness between 1 and 40 mm, preferably between 3 and 30 mm, more preferably between 5 and 25 mm. The slices of the gelled fish muscle tissue analogue may have thickness between 1 and 40 mm, preferably between 3 and 30 mm, more preferably between 8 and 25 mm. Preferably, the slices of the gelled fish connective tissue analogue may have thickness between 1 and 5 mm, preferably between 2 and 4 mm. Most preferably the slices of the gelled fish muscle tissue analogue have thickness between 3 and 30 mm, more preferably between 8 and 25 mm and the slices of the gelled fish connective tissue analogue a thickness of between 1 and 5 mm, preferably between 2 and 4 mm. As the thickness of the slices corresponds to the height of the layers in the raw fish analogue, the aforementioned preferred thickness of slices corresponds to the preferred heights of the corresponding layers. Preferably a layered stack is prepared of at least three layers by taking a first slice of the gelled fish muscle tissue analogue composition M to form a first layer, placing a slice of the gelled fish connective tissue analogue C on top of first slice M to form the second layer, placing another slice of gelled fish muscle tissue composition M on top of C to form the third layer, optionally adding more slices of M and C in alternating order.

A subsequent step comprises fusing the alternating layers in the layered stack to each other by heating the layered stack to at least melt a part of the layered stack, followed by cooling the layered stack to re-gel the melted part thereby forming a stack of fused layers. Preferably said heating of the layered stack is to above the melting temperature of the thermo-reversible composition C, preferably cooling of the layered stack is to below said melting temperature. If the gelled composition M is also thermo-reversible, the heating may also above the melting temperature of composition M, and the cooling below said temperature. Preferably the layered stack heated to at least 60° C., more preferably to at least 70° C., even more preferably to at least 80° C. Preferably, the layered stack is heated to at most 100° C. Preferably the layered stack heated to 60 to 100° C., more preferably to at least 70 to 100° C., even more preferably to at least 80 to 95° C. Preferably the layered stack cooled to lower than 40° C., more preferably to lower than 30° C., even more preferably to lower than 20° C. Preferably, the layered stack is cooled not lower than −5° C. Preferably the layered stack cooled to 0 to 40° C., more preferably to at least 0 to 30° C., even more preferably to at least 5 to 20° C.

A subsequent step comprises slicing the stack of fused layers to form slices of raw fish tissue analogue whereby the slices have a layered appearance showing alternating layers of the gelled muscle tissue analogue composition M and the gelled connective tissue analogue composition C, preferably whereby the layered appearance shows at least one layer of the gelled connective tissue analogue composition C between two layers of the gelled muscle tissue analogue composition M.

The present invention is more cost effective than other food manufacturing processes such as injection molding. Injection molding is a technique for preparing food products involving injecting one or more food materials into a mold to produce an article with a shape and size of the mold. The use of molds results in food products with an artificial identical appearance. Injection as a food manufacturing process is typically a costly process which requires expensive specialised pumps and injectors, is prone to malfunction due to e.g. clogging and therefore hardly suitable for large scale industrial production. Preferably, the process according to the present invention does not include injection molding. Preferably, the process according to the present invention does not require the use of molds.

### Gelled Fish Muscle Tissue Analogue Composition M

The gelled fish muscle tissue analogue composition is preferably a thermo-reversible gel. The term “gel” and “gelled” as used herein are preferably intended to refer to a hydrocolloid gum composition that can be sliced into slices of at 2 mm thick at 25° C., whereby slices of 2 mm thick, length of 10 cm and a width of 2 cm can pick up by hand without breaking at 25° C. Surprisingly, a further advantage of the process according to the invention was to have certain G′ to improve processing of the gel during the various steps such as slicing and/or stacking. Preferably, the gelled fish muscle tissue analogue composition has a G′ at 20° C. of at least 5 000 Pa s, more preferably at least 10 000 Pa s, even more preferably at least 15 000 Pa s, even more preferably at least 20 000 Pa s, most preferably at least 25 000 Pa s. A desired G′ can be obtained by using a sufficiently high amount of gelling agents and/or protein.

The gel is prepared as usual: gelling agents like gum are hydrated in water, heated and cooled. Preferably the gelled fish muscle tissue analogue is prepared by mixing water, gums, non-animal protein and optionally non-chemically modified starch, flavouring agents and colouring agents. If a protein isolate or protein concentrate is used, it is preferred these have not been pre-heated before admixing with the other ingredients. The mixing is carried out with a sufficient amount of water for sufficient amount of time to hydrate the ingredients. If liquid oil is admixed, the mixture is sheared at a rate sufficient to form an emulsion which shows no phase separation before the following step in the process. This mixture of hydrated ingredients is then heated and subsequently cooled to form the gelled fish muscle tissue analogue composition. Heating is applied such that the gelling agents form a gel after cooling. Heating is generally to temperature of at least 60° C. for at least 10 min. Cooling is usually to a temperature below the gelling point such as to at most 50° C., preferably to at most 40° C., more preferably to at most 30° C.

Preferably the gums comprise at least 2 gums, more preferably at least 3 gums. Preferred gums include carrageenan gum, galactomannan gum, xanthan gum. A preferred combination comprises kappa-carrageenan gum and galactomannan gum. An even more preferred combination comprises kappa-carrageenan gum, galactomannan gum and xanthan gum. Galactomannan gum includes guar gum, cassia gum and locust bean gum.

Preferably, comprises the gelled fish muscle tissue analogue composition comprises 2 to 5 wt %, more preferably 2 to 3.5 wt % of carrageenan gum by weight of the total gelled fish muscle tissue analogue composition.

Preferably, comprises the gelled fish muscle tissue analogue composition comprises 0.3 to 2 wt %, preferably 0.5 to 1.5 wt % of galactomannan gum by weight of the total gelled fish muscle tissue analogue composition.

Preferably carrageenan and galactomannan gum are used, preferably the sum of carrageenan and galactomannan gum in the gelled fish muscle tissue analogue composition by weight of the gelled fish muscle tissue analogue composition is from 2 to 7 wt %, more preferably from 2.5 to 6 wt % even more preferably 3 to 5 wt %. Preferably, the w/w ratio of carrageenan gum to galactomannan gum in the gelled fish muscle tissue analogue composition at least 1, preferably at least 1.2, more preferably at least 1.5, even more preferably at least 2.

Preferably, the w/w ratio of carrageenan gum to galactomannan gum in the gelled fish muscle tissue analogue composition from 1 to 10, preferably at least 1.2 to 8, more preferably at least 1.5 to 5, even more preferably at least 2.to 4. Unexpectedly, it was found that having such ratios resulted in improved handling

Surprisingly, adding xanthan gum improved the fusing of the layers improving the coherence of the layers when the stack was sliced. Preferably, the gelled fish muscle tissue analogue composition further comprises by weight of the gelled fish muscle tissue analogue composition 0.05 to 1.0 wt %, more preferably 0.1 to 0.5 wt % even more preferably 0.1 to 0.3 wt % of xanthan gum.

Preferably the G″ at 85° C. of the gelled fish muscle tissue analogue is at least 35 Pa s, more preferably at least 40 Pa s, even more preferably at least 50 Pa s.

Preferably, the pH of the gelled fish muscle tissue analogue is 4 to 7, more preferably 4.1 to 6.4, even more preferably 4.2 to 5.9.

Most preferably the gelled fish muscle tissue analogue composition comprises by weight of the gelled fish muscle tissue analogue composition
i) 0.3 to 2 wt %, preferably 0.5 to 1.5 wt % of galactomannan gum;
ii) 2 to 5 wt %, preferably 2 to 3.5 wt % of kappa carrageenan gum;
iii) 0.05 to 1.0 wt %, preferably 0.1 to 0.5 wt % of xanthan gum;
iv) 5 to 10 wt %, preferably 6.0 to 7.5 wt % of non-animal protein, preferably legume protein, more preferably pea or soy protein, even more preferably pea protein, preferably added as a protein isolate;
v) preferably 3 to 20 wt %, more preferably 6 to 18 wt %, even more preferably 8 to 16 wt % of liquid oil

Preferably whereby the combined amount of protein and liquid oil is at least 8 wt %, more preferably at least 11 wt %, even more preferably at least 13 w %, even more preferably of from 8 to 30 wt %, more preferably 11 to 24 wt %, even more preferably 13 to 22 wt %,
vi) colouring agent, preferably in an amount of at least 0.05 wt %, more preferably at least 0.1 wt %, even more preferably at least 0.5 wt %, preferably in an amount of 0.05 to 5 wt % of more preferably 0.1 to 3 wt %, even more preferably 0.5 to 2 wt %,
vii) flavouring agent, preferably in an amount of 0.1 to 5 wt % of flavouring agent, more preferably of 0.2 to 3 wt %, even more preferably 0.5 to 2 wt %;
viii) preferably 0.2 to 7 wt % of starch, preferably non-chemically modified starch, more preferably physically modified starch, even more preferably physically modified potato starch.

### Gelled Fish Connective Tissue Analogue Composition C

The process to prepare a raw fish tissue analogue according to the invention comprises providing a gelled fish connective tissue analogue composition, preferably as described more detail infra. At least one, preferably both of the two gelled analogue compositions M and C are a thermo-reversible gel. Preferably, both gelled compositions are non-extruded composition, i.e. they have not been produced using an extruder such as single screw or twin screw extruder.

The gelled fish connective tissue analogue composition is preferably a thermo-reversible gel. Surprisingly a further advantage of the process according to the invention was to have certain G′ to improve the processing of the gel during the various steps such as slicing and/or stacking. Preferably, the gelled fish connective tissue analogue composition has a G′ at 20° C. is at least 5 000 Pa s, more preferably at least 10 000 Pa s, even more preferably at least 15 000 Pa s, even more preferably at least 20 000 Pa s, most preferably at least 25 000 Pa s. A desired G′ can be obtained by using a sufficiently high amount of gelling agents and protein.

The gel is prepared as usual and in general as described above for composition M.

Preferably the gelled fish connective tissue analogue composition comprises at least 2 gums, more preferably at least 3 gums. Preferred gums include carrageenan gum, galactomannan gum, xanthan gum. A preferred combination comprises kappa-carrageenan gum and galactomannan gum. An even more preferred combination comprises kappa-carrageenan gum, galactomannan gum and xanthan gum.

Preferably, the gelled fish connective tissue analogue composition comprises 2 to 5 wt %, more preferably 2 to 3.5 wt % of carrageenan gum weight of the total gelled fish connective tissue analogue composition.

Preferably, comprises the gelled fish connective tissue analogue composition comprises 0.3 to 2 wt %, preferably 0.5 to 1.5 wt % of galactomannan gum weight of the total gelled fish connective tissue analogue composition.

Preferably carrageenan and galactomannan gum are used, preferably the sum of carrageenan and galactomannan gum in the gelled fish connective tissue analogue composition by weight of the gelled fish connective tissue analogue composition is from 2 to 7 wt %, more preferably from 2.5 to 6 wt % even more preferably 3 to 5 wt %. Preferably, the w/w ratio of carrageenan gum to galactomannan gum in the gelled fish connective tissue analogue composition at least 1, preferably at least 1.2, more preferably at least 1.5, even more preferably at least 2.

Preferably, the w/w ratio of carrageenan gum to galactomannan gum in the gelled fish connective tissue analogue composition from 1 to 10, preferably at least 1.2 to 8, more preferably at least 1.5 to 5, even more preferably at least 2.to 4. Unexpectedly, it was found that having such ratios resulted in improved handling during slicing and layering but still obtaining mouthfeel similar to real raw salmon.

Surprisingly, adding xanthan gum improved the fusing of the layers improving the coherence of the layers when the stack was sliced. Preferably, the gelled fish connective tissue analogue composition further comprises by weight of the gelled fish connective tissue analogue composition 0.05 to 1.0 wt %, more preferably 0.1 to 0.5 wt % even more preferably 0.1 to 0.3 wt % of xanthan gum weight of the total gelled fish connective tissue analogue composition.

Preferably the G″ at 85° C. of the gelled fish connective tissue analogue is at least 35 Pa s, more preferably at least 40 Pa s, even more preferably at least 50 Pa s.

Preferably, the pH of the gelled fish connective tissue analogue is 4 to 7, more preferably 4.1 to 6.4, even more preferably 4.2 to 5.9.

Most preferably the gelled fish connective tissue analogue composition comprises by weight of the total gelled fish connective tissue analogue composition
i) 0.3 to 2 wt %, preferably 0.5 to 1.5 wt % of galactomannan gum;
ii) 2 to 5 wt %, preferably 2 to 3.5 wt % of kappa carrageenan gum;
iii) 0.05 to 1.0 wt %, preferably 0.1 to 0.5 wt % of xanthan gum;
iv) 5 to 10 wt %, preferably 6.0 to 7.5 wt % of non-animal protein, preferably legume protein, more preferably pea or soy protein, even more preferably pea protein, preferably added as a protein isolate;
v) preferably 3 to 20 wt %, more preferably 6 to 18 wt %, even more preferably 8 to 16 wt % of liquid oil

Preferably whereby the combined amount of protein and liquid oil is at least 8 wt %, more preferably at least 11 wt %, even more preferably at least 13 w %, even more preferably of from 8 to 30 wt %, even more preferably 11 to 24 wt %, even more preferably 13 to 22 wt %;
vi) optionally colouring agent, preferably in an amount of at least 0.05 wt %, more preferably at least 0.1 wt %, even more preferably at least 0.5 wt %, preferably in an amount of 0.05 to 5 wt % of more preferably 0.1 to 3 wt %, even more preferably 0.5 to 2 wt %,
vii) flavouring agent, preferably in an amount of 0.1 to 5 wt % of flavouring agent, more preferably of 0.2 to 3 wt %, even more preferably 0.5 to 2 wt %;
viii) preferably 0.2 to 7 wt % of starch, preferably non-chemically modified starch, more preferably physically modified starch, even more preferably physically modified potato starch.

The gelled fish connective tissue analogue preferably has colour similar to that of the real fish usually light or whitish. Preferably colouring agents need to be used although some plant based ingredients may be used to get the desired hue.

Preferably, the gelled fish connective tissue analogue comprises weight of the total gelled fish connective tissue analogue composition less than 0.1 wt %, more preferably less than 0.01 wt % of titanium dioxide. Preferably, the gelled fish connective tissue analogue is substantially free of titanium dioxide.

Preferably, the gelled fish connective tissue analogue comprises less than 0.1 wt %, more preferably less than 0.01 wt % of calcium salt particles such as calcium carbonate particles weight of the total gelled fish connective tissue analogue composition. Preferably, the gelled fish connective tissue analogue is substantially free of calcium salt particles such as calcium carbonate particles. Preferably, the gelled fish connective tissue analogue comprises less than 0.1 wt %, more preferably less than 0.01 wt % of insoluble fiber weight of the total gelled fish connective tissue analogue composition. Preferably, the gelled fish connective tissue analogue is substantially free of insoluble fiber.

Preferably, the gelled fish connective tissue analogue comprises less than 0.1 wt %, more preferably less than 0.01 wt % of insoluble fiber weight of the total gelled fish connective tissue analogue composition. Preferably, the gelled fish connective tissue analogue is substantially free of insoluble fiber.

The third step c) of the process according to the invention comprises the step of slicing the gelled raw fish muscle tissue analogue composition to form slices of said composition M.

The fourth step d) of the process according to the invention comprises the step slicing the gelled raw fish connective tissue analogue composition to form slices of said composition C.

The fifth step e) of the process according to the invention comprises the step of making layered stack of slices whereby slices of the gelled raw fish muscle tissue analogue composition M are layered alternately with the gelled raw fish connective tissue analogue composition C to form a layered stack with a layered appearance.

In step d) of the process according to the invention comprises the step of fusing the alternating layers in the layered stack to each other by heating and cooling the layered stack to form a stack of fused layers. Preferably in step d) of fusing the alternating layers, the layered stack is heated such that the part where adjacent gelled slices contact each other at least partially melts and is subsequently cooled such that the at least partially melted part re-solidifies thereby fusing the slices to each other.

Optionally the layered stack may be smoked below the melting temperature of the raw fish analogue to produce a smoked raw fish tissue analogue.

The subsequent step comprises the step of slicing the stack of fused layers to form slices of raw fish tissue analogue whereby the slices show alternating layers of gelled raw fish muscle tissue analogue composition M and the gelled raw fish connective tissue analogue composition C.

### Raw Fish Tissue Analogue

The raw fish tissue analogue according to invention is designed to resemble real raw fish in appearance, taste, smell and mouthfeel but without the use of fish protein. Preferably the raw fish tissue analogue is a vegan fish analogue, i.e., free from any animal protein. The raw fish tissue analogue according to invention is designed to be consumed without heating the product, preferably the raw fish tissue analogue is thermo-reversible: it would melt when cooked and not resemble e.g., fish which has been cooked in a pan. The raw fish tissue analogue preferably comprises alternating layers of gelled fish muscle tissue analogue composition M respectively a gelled fish connective tissue analogue composition C.

Surprisingly a further advantage of the process according to the invention was to have certain G′ to improve the processing of the gel during the various steps such as slicing and/or stacking. Preferably, the raw fish tissue analogue composition has a G′ at 20° C. is at least 5 000 Pa s, more preferably at least 10 000 Pa s, even more preferably at least 15 000 Pa s, even more preferably at least 20 000 Pa s, most preferably at least 25 000 Pa s. Preferably the G″ at 85° C. of the raw fish tissue analogue composition is at least 35 Pa s, more preferably at least 40 Pa s, even more preferably at least 50 Pa s.

Preferably the raw fish tissue analogue composition comprises at least 2 gums, more preferably at least 3 gums. Preferred gums include carrageenan gum, galactomannan gum, xanthan gum. A preferred combination comprises kappa-carrageenan gum and galactomannan gum. An even more preferred combination comprises kappa-carrageenan gum, galactomannan gum and xanthan gum.

Preferably, the raw fish tissue analogue composition comprises 2 to 5 wt %, more preferably 2 to 3.5 wt % of carrageenan gum weight of the total raw fish tissue analogue composition. Preferably, comprises the raw fish tissue analogue composition comprises 0.3 to 2 wt %, preferably 0.5 to 1.5 wt % of galactomannan gum weight of the total raw fish tissue analogue composition.

Preferably carrageenan and galactomannan gum are used, preferably the sum of carrageenan and galactomannan gum in the raw fish tissue analogue composition by weight of the raw fish tissue analogue composition is from 2 to 7 wt %, more preferably from 2.5 to 6 wt % even more preferably 3 to 5 wt %. Preferably, the w/w ratio of carrageenan gum to galactomannan gum in the raw fish tissue analogue composition at least 1, preferably at least 1.2, more preferably at least 1.5, even more preferably at least 2.

Preferably, the w/w ratio of carrageenan gum to galactomannan gum in the raw fish tissue analogue composition from 1 to 10, preferably at least 1.2 to 8, more preferably at least 1.5 to 5, even more preferably at least 2.to 4. Unexpectedly, it was found that having such ratios resulted in improved handling

Surprisingly, xanthan gum improved the fusing of the layers improving the coherence of the layers when the stack was sliced. Preferably, the raw fish tissue analogue composition further comprises by weight of the raw fish tissue analogue composition 0.05 to 1.0 wt %, more preferably 0.1 to 0.5 wt % even more preferably 0.1 to 0.3 wt % of xanthan gum weight of the total raw fish tissue analogue composition.

Preferably the G″ at 85° C. of the raw fish tissue analogue is at least 35 Pa s, more preferably at least 40 Pa s, even more preferably at least 50 Pa s.

Preferably, the pH of the raw fish tissue analogue is 4 to 7, more preferably 4.1 to 6.4, even more preferably 4.2 to 5.9.

Most preferably the raw fish tissue analogue composition comprises by weight of the total raw fish tissue analogue composition
i) 0.3 to 2 wt %, preferably 0.5 to 1.5 wt % of galactomannan gum;
ii) 2 to 5 wt %, preferably 2 to 3.5 wt % of kappa carrageenan gum;
iii) 0.05 to 1.0 wt %, preferably 0.1 to 0.5 wt % of xanthan gum;
iv) 5 to 10 wt %, preferably 6.0 to 7.5 wt % of non-animal protein, preferably legume protein, more preferably pea or soy protein, even more preferably pea protein, preferably added as a protein isolate;
v) preferably 3 to 20 wt %, more preferably 6 to 18 wt %, even more preferably 8 to 16 wt % of liquid oil,

Preferably whereby the combined amount of protein and liquid oil is at least 8 wt %, more preferably at least 11 wt %, even more preferably at least 13 w %, even more preferably of from 8 to 30 wt %, more preferably 11 to 24 wt %, even more preferably 13 to 22 wt %,
vi) colouring agent, preferably in an amount of at least 0.05 wt %, more preferably at least 0.1 wt %, even more preferably at least 0.5 wt %, preferably in an amount of 0.05 to 5 wt % of more preferably 0.1 to 3 wt %, even more preferably 0.5 to 2 wt %,
vii) flavouring agent, preferably in an amount of 0.1 to 5 wt % of flavouring agent, more preferably of 0.2 to 3 wt %, even more preferably 0.5 to 2 wt %;
viii) preferably 0.2 to 7 wt % of starch, preferably non-chemically modified starch, more preferably physically modified starch, even more preferably physically modified potato starch. Preferably, the raw fish tissue analogue is a raw salmon analogue or a raw tuna analogue.

Preferably the raw fish tissue analogue according to the invention is substantially free of isolated and purified heme-containing protein, preferably substantially free of isolated and purified leg heme-containing protein. As used herein, the term “isolated and purified’ indicates that the preparation of heme-containing protein is at least 60% pure, preferably at least 80%, most preferably at least 90/w pure.

Preferably, the raw fish tissue analogue comprises weight of the total raw fish tissue analogue less than 0.1 wt %, more preferably less than 0.01 wt % of titanium dioxide. Preferably, the raw fish tissue analogue is substantially free of titanium dioxide.

Preferably, the raw fish tissue analogue comprises less than 0.1 wt %, more preferably less than 0.01 wt % of calcium carbonate particles weight of the total raw fish tissue analogue. Preferably, the raw fish tissue analogue is substantially free of calcium carbonate particles.

Preferably, the raw fish tissue analogue comprises less than 0.1 wt %, more preferably less than 0.01 wt % of starch acetate weight of the total raw fish tissue analogue. Preferably, the raw fish tissue analogue is substantially free of starch acetate.

### Non-Animal Protein

The raw fish tissue analogue preferably comprises non-animal protein such as legume protein. Preferably, the non-animal protein is added as a non-animal protein isolate. Preferred proteins include pea and soy protein. Preferably these can be added as pea protein isolate respectively soy protein isolate. The amount of non-animal protein is preferably between 5 to 10 wt %, preferably 6.0 to 7.5 wt % by weight of the raw fish tissue analogue. Surprisingly, the present invention provides raw fish tissue analogue with relatively high amounts of protein without gritty mouthfeel or phase separation. Preferably, the non-animal protein is a plant protein. Preferred examples of plant protein comprise legume protein (e.g., soy protein, pea protein, mung bean protein) sunflower protein, rape seed protein oat protein, wheat protein, rice protein. Most preferred plant protein is legume protein, preferably selected from soy protein, pea protein and combinations thereof.

Chunks of texturized vegetable protein are normally used in most if not all meat analogues on the market. Texturized protein in this field of technology refers to fibrous protein produced by cooking the e.g. legume flour or legume protein concentrate with water in an extruder cooker and extruding them to form a texturized protein whereby the protein forms protein fibers. Surprisingly, we have found that the mouthfeel of raw fish analogues can be further improved if the raw fish tissue analogue comprises little or no texturized protein. Preferably less than 20 wt %, more preferably less than 10 wt %, even more preferably less than 1 wt % of the non-animal protein is texturized vegetable protein. Preferably, the raw fish tissue analogue comprises less than 0.5 wt %, more preferably less than 0.1 wt %, even more preferably 0 wt % of texturized vegetable protein. Preferably, the raw fish tissue analogue is substantially free of texturized vegetable protein. Preferably, the non-animal protein is not present as texturized vegetable protein.

### Liquid Oil

The raw fish tissue analogue according to the invention preferably comprises liquid oil in the gelled fish muscle tissue analogue composition M and/or gelled fish tissue connective analogue composition C.

The term “liquid oil” as used herein refers to an oil that contains no solid at 20° C. (N20=0%). The solid fat content at 20° C. can be determined using ISO method ISO 8292-2:2008. Preferably, raw fish tissue analogue according to the invention comprises 3 to 20 wt % of liquid oil, more preferably 6 to 18 wt %, even more preferably 8 to 16 wt % by weight of the total raw fish analogue. Liquid oil may be used as ingredient of either gelled composition. Surprisingly, it was found that the present invention allows the use of relatively high amounts of liquid oil without phase separation and avoiding a too soft product.

Preferred liquid oils include one or more of vegetable oils such as, sunflower oil, corn oil, soybean oil, safflower oil, flaxseed oil. rice bran oil, cottonseed oil, olive oil, and canola oil. In particular, it is preferred to combine vegetable oils include those having omega-3 fatty acids eicosapentaenoic acid (EPA) and docosahexaenoic acid (DHA) such as algal oil and fish oil. One preferred oil having EPA and DHA is algal oil. The level of inclusion of oils having EPA and/or DHA such as algal oil depends on the maximum allowable levels of EPA/DHA according to the relevant food regulation. For algal oil, a preferred inclusion level is 0.1 to 0.4 wt % of algal oil.

One of the advantages of the present invention is that it provides a robust process which provides the skilled person with increased formulation flexibility to use—if so desired—relatively high amounts of protein and oil and still get the desirable mouthfeel without processing tissues like phase separation and foaming.

Preferably the combined amount of protein and liquid oil is at least 8 wt %, more preferably at least 11 wt %, even more preferably at least 13 w %, even more preferably of from 8 to 30 wt %, even more preferably 11 to 24 wt %, even more preferably 13 to 22 wt % by weight of the raw fish tissue analogue.

### Colouring Agent

The raw fish tissue analogue according to the invention preferably comprises colouring agent, preferably 0.05 to 5 wt % of colouring agent, more preferably 0.1 to 3 wt %, even more preferably 0.5 to 2 wt % by weight of the total raw fish tissue analogue composition. The raw fish tissue analogue according to the invention preferably comprises at least 0.05 wt %, more preferably at least 0.1 wt %, even more preferably at least 0.5 wt % of colouring agent, by weight of the total raw fish tissue analogue composition. Any food grade colouring agent to provide the desired raw fish like colour may be used. Preferably, the colouring agent is a plant-based coloring agent.

### Flavouring Agent

The raw fish tissue analogue according to the invention preferably comprises flavouring agent, preferably 0.1 to 5 wt % of flavouring agent, more preferably 03 to 3 wt %, even more preferably 5 to 2 wt % by weight of the total composition. Any food grade flavouring agent to provide the desired flavour may be used. Examples include, fish flavour, smoke flavour, taste enhancer, yeast extract, spices, herbs, and combinations thereof.

### Other Ingredients

The raw fish tissue analogue according to the invention preferably comprises 0.1 to 3 wt %, more preferably less than 0.1 to 2 wt % even more preferably less than 0.1 to 1 wt % of NaCl by weight of the total raw fish analogue. The raw fish tissue analogue according to the invention preferably comprises less than 5 wt %, more preferably less than 3 wt % even more preferably less than 1 wt % of sugar by weight of the total raw fish analogue. The raw fish tissue analogue according to the invention preferably comprises 0.1 to 10 wt %, more preferably less than 0.2 to 7 wt % even more preferably less than 0.3 to 3 wt % of food grade acid by weight of the total raw fish tissue analogue. The raw fish tissue analogue according to the invention may comprise starch, preferably non-chemically modified starch, more preferably physically modified starch, even more preferably physically modified potato starch, preferably in an amount of from 0.1 to 10 wt %, more preferably less than 0.2 to 7 wt % even more preferably less than 0.3 to 3 wt % of physically modified starch and/or native starch. Surprisingly, we have found that the mouthfeel of raw fish analogues can be further improved if the raw fish tissue analogue comprises less than 0.5 wt %, more preferably less than 0.1 wt %, even more preferably 0 wt % of chemically modified starch such as starch acetate. Preferably, the raw fish tissue analogue is substantially free of chemically modified starch such as starch acetate.

### Packaging

The raw fish tissue analogue is preferably packaged. Preferably, it is packaged under a modified atmosphere, or even more preferred under vacuum. A modified atmosphere as used herein refers to an internal atmosphere in the packaging having a different composition than ambient atmosphere. Usually, the modified atmosphere will have an oxygen concentration which is lower than ambient atmosphere like a ratio of O₂:N₂:CO₂ of 0:50:50. It is also possible to have more oxygen e.g. 70 O₂:30 CO₂. Preferably, the modified atmosphere is one from which oxygen is substantially depleted or increased to more than 30 vol %. Slices of raw fish tissue analogue may also be packaged under vacuum.

### G′ and G″ Measurement Protocol

Small-amplitude oscillatory shear measurements of raw fish tissue analogue samples in various conditions were carried out using an Anton Paar MCR-301 stress-controlled rheometer (Anton Paar GmbH, Austria) fitted with a concentric cylinder (CC27) and a Peltier temperature control unit.

After overnight storage at 4° C., approximately 20 ml of sample was inserted in the geometry. To inhibit solvent evaporation during measurement, a thin layer of low viscosity paraffin oil was floated on top of the sample. Temperature sweeps were then performed in the linear domain of raw fish tissue analogue samples in the temperature range of 20-85° C. A first temperature ramp is performed from 20 to 85° C. to replicate the first heating step during processing. The storage (G′) and loss (G″) moduli are recorded as functions of temperature throughout the process at a frequency of 0.1 Hz and a strain of 0.01. A heating and cooling rate of 1° C./min was applied during the measurement. The G″ at 85° C. was used while the G′ at 20° C. was used.

### DRAWINGS

### Brief Description of the Figures

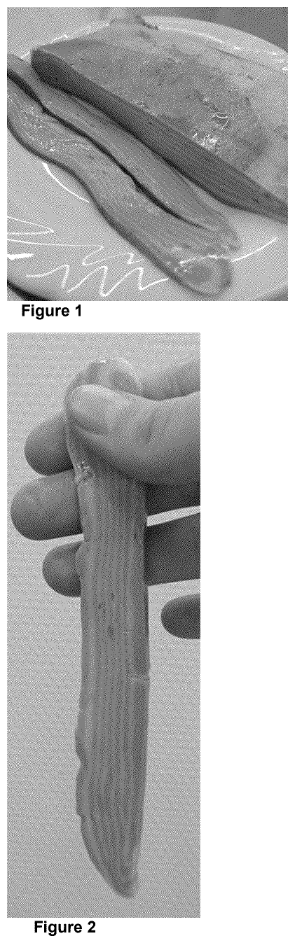

FIG. 1 shows a slice of a stack of a raw salmon analogue (Example 1)

FIG. 2 shows a slice a raw salmon analogue

### EXAMPLES

The invention is further illustrated by the following non-limiting examples. It will be clear to the skilled person how to carry out the invention by using equivalent means without departing from the invention.

### Example 1

A gelled salmon muscle tissue analogue composition was prepared as follows (expressed as w/w % of the gelled salmon connective tissue analogue composition: 2.7 wt % kappa carrageenan, 6.5 wt % of pea protein isolate (Ingredion Vitessence pulse 1853), 1 wt % of native potato starch, 0.75 wt % of guar gum, 0.15 wt % of xanthan gum, 2.8 wt % of dextrose, 1.18 wt % of NaCl, 10.52 wt % of sunflower oil, 0.3 wt % of algal oil were admixed with water with sufficient shear to form a stable homogenous emulsion (water was balanced to 100 wt % of the gelled salmon muscle tissue analogue composition) (Thermomix TM5 [Voorwerk] speed 5 for 2 min (2000 rpm)). 0.61 wt % of acid was admixed (speed 5 for 30 sec). Finally, 1 wt % of flavouring agents and 1.1 wt % of orange colouring agents were admixed (speed 5 for 30 sec). The mixture was placed in a bag and heated at 95° C. for 30 min in full steam and subsequently cooled in ice water to form the gelled salmon muscle tissue analogue composition. The pH was 4.7. No significant foaming or phase separation was observed allowing the subsequent mixing steps to be carried out without delay. The w/w ratio carrageenan to galactomannan was 3.6.

A gelled salmon connective tissue analogue composition was prepared in the same manner except that the 1.1 wt % colouring agents were replaced by water. Again, no significant foaming was observed. Surprisingly, despite the relatively high amounts of oil and protein no phase separation was observed and no gritty mouthfeel.

The respective gelled compositions were sliced to form slices of the respective gelled compositions whereby the slices of the salmon muscle tissue analogue composition were about 0.5 to 1 cm thick while the slices of gelled salmon connective tissue analogue composition were about 3-5 mm thick. Both compositions M and C were surprisingly well sliceable. Subsequently, the layers were stacked alternating the orange-coloured layers of salmon muscle tissue analogue with white layers of salmon connective tissue analogue such that seen from the side the stack had a layered appearance of orange with white stripes, similar to real raw salmon (see FIG. 1). The G′ at 20° C. was 24639 Pa s and the G″ at 85° C. was 54 Pa s.

In a following step the layered stack was fused by heating it at 95° C. for 30 minutes and then cooled in ice water. To maintain the layered appearance in this step the layered stack was heated in a bag which was vacuum sealed. The stack was finally sliced into slices of raw salmon analogue having the appearance of real smoked raw salmon: orange layers with white stripes in between.

### Tasting

The raw salmon analogue was compared by a tasting panel consisting of 9 people to real smoked salmon (reference). The panel scored the samples on mouthfeel (firmness, sliminess, oiliness) and visual appearance. Example 1, in particular, the mouthfeel, was judged to be very similar to the real raw salmon.

Example 2 A raw salmon analogue according to the invention was prepared according to example 1 except that the amount of guar gum was 1.5 wt % (balance water).

Example 3 Raw salmon analogue compositions with the following differences compared to example 1 (preparation see example 1). The respective gelled salmon connective tissue analogue compositions for 2.1 to 2.6 are the same but without the colouring agents.

Gelled salmon muscle tissue analogue composition

| w/w % | 2.1 | 2.2 | 2.3 | 2.4 | 2.5 | 2.6 |
|---|---|---|---|---|---|---|
| Galactomannangum | 0.5 | 0.6 | 1.2 | 0.5 | 0.6 | 1.2 |
| Kappa carrageenan | 3.5 | 2.9 | 2.2 | 3.5 | 2.9 | 2.2 |
| gum | | | | | | |
| Xanthan gum | 0.3 | 0.2 | 0.05 | 0.3 | 0.2 | 0.05 |
| Guar gum | | | | | | |
| Pea protein isolate | 7 | | 5 | 5 | | 7 |
| Soy protein isolate | | 9 | | | 9 | |
| Native starch | 1.5 | 0.8 | 0 | 1.5 | 0.8 | 0 |
| w/w ratio carrageenan | 7 | 4.8 | 1.8 | 7 | 4.8 | 1.8 |
| to galactomannan | | | | | | |

All ingredients were sourced from EU, CN, and or USA.

1. Process for preparing a raw fish tissue analogue which is substantially free of konjac mannan gum comprising the steps of
a) providing a slice of thermo-reversible gelled fish muscle tissue analogue composition M;
b) providing a slice of thermo-reversible gelled fish tissue connective analogue composition C; whereby preferably said gelled compositions M and C are visually distinct and preferably said slices have been obtained by slicing respectively
i. a body of the gelled tissue analogue composition M to form slices of said composition
ii. a body of the gelled tissue analogue composition C to form slices of said composition;
c) making a layered stack of slices whereby slices of the gelled compositions M and C are layered alternately to form a stack with a layered appearance;
d) fusing the alternating layers in the layered stack to each other by heating the layered stack to above the melting temperature of composition M and/or C followed by cooling the layered stack to below said melting temperature to form a stack of fused layers resulting in a body of raw fish tissue analogue;
e) optionally, slicing the stack of fused layers to form slices of raw fish tissue analogue whereby the slices have a layered appearance showing alternating layers of the gelled muscle tissue analogue composition M and the gelled connective tissue analogue composition C, preferably whereby the layered appearance shows at least one layer of the gelled connective tissue analogue composition C between two layers of the gelled muscle tissue analogue composition M; and
preferably whereby the raw fish tissue analogue is a raw salmon analogue or a raw tuna analogue.

2. A process according to claim 1 whereby the slices of raw fish tissue analogue of step h) have a thickness of 1 to 40 mm.

3. A process according to claim 1, whereby the G′ at 20° C. of the gelled fish muscle tissue analogue composition is at least 5 000 Pa s, whereby G′ is measured as described herein.

4. A process according to claim 1, wherein at least one of the compositions M and C has a pH of 4 to 7.

5. A process according to claim 1, whereby the raw fish tissue analogue comprises galactomannan gum and carrageenan gum whereby the w/w ratio between carrageenan gum and galactomannan gum is at least at least 1.

6. A process according to claim 1, whereby the raw fish tissue analogue further comprises 3 to 20 wt % of liquid oil by weight of the raw fish tissue analogue composition.

7. A process according to claim 1, whereby at least one of compositions M and composition C further comprises xanthan gum.

8. A process according to claim 1, whereby the raw fish tissue analogue further comprises 5 to 10 wt % of non-animal protein.

9. A process according to claim 1, whereby the raw fish tissue analogue comprises non-animal protein and liquid oil, whereby the combined amount of protein and liquid oil is at least 8 wt %.

10. A raw fish tissue analogue which is substantially free of konjac mannan gum comprising alternating layers of
a) thermo-reversible gelled fish muscle tissue analogue composition M;
b) thermo-reversible gelled fish tissue connective analogue composition C;
whereby the raw fish tissue analogue has a layered appearance showing alternating layers of the gelled muscle tissue analogue composition M and the gelled connective tissue analogue composition C, preferably whereby the layered appearance shows at least one layer of the gelled connective tissue analogue composition C between two layers of the gelled muscle tissue analogue composition M;
whereby preferably said gelled compositions M and C are visually distinct and are substantially free of titanium dioxide;
whereby the alternating layers have been fused to each other by heating a stack of alternating gelled layers of M and C followed by cooling, and preferably whereby the raw fish tissue analogue is thermo-reversible.

11. A raw fish tissue analogue according to claim 10 whereby the raw fish tissue analogue has a G′ at 20° C. of at least 5 000 Pa s, whereby G′ is measured as described herein.

12. A raw fish tissue analogue according to claim 10, whereby at least one of compositions M and composition C comprises galactomannan gum, carrageenan gum and xanthan gum.

13. A raw fish tissue analogue according to claim 12, whereby the w/w ratio between carrageenan gum and galactomannan gum is at least at least 1.

14. A raw fish tissue analogue according to claim 10, further comprises non-animal protein and liquid oil, whereby the combined amount of protein and liquid oil is at least 8 wt %.

15. A raw fish tissue analogue according to claim 10, comprising
i) 0.3 to 2 wt %, preferably 0.5 to 1.5 wt % of galactomannan gum;
ii) 2 to 5 wt %, preferably 2 to 3.5 wt % of kappa carrageenan gum;
iii) 0.05 to 1.0 wt %, preferably 0.1 to 0.5 wt % of xanthan gum;
iv) 5 to 10 wt %, preferably 6.0 to 7.5 wt % of non-animal protein, preferably legume protein, more preferably pea or soy protein, even more preferably pea protein, preferably added as a protein isolate;
v) preferably 3 to 20 wt %, more preferably 6 to 18 wt %, even more preferably 8 to 16 wt % of liquid oil;
Preferably whereby the combined amount of protein and liquid oil is at least 8 wt %, more preferably at least 11 wt %, even more preferably at least 13 w %, even more preferably of from 8 to 30 wt %, even more preferably 11 to 24 wt %, even more preferably 13 to 22 wt %;
vi) colouring agent, preferably in an amount of at least 0.05 wt %, more preferably at least 0.1 wt %, even more preferably at least 0.5 wt %, preferably in an amount of 0.05 to 5 wt % of more preferably 0.1 to 3 wt %, even more preferably 0.5 to 2 wt %;
vii) flavouring agent, preferably in an amount of 0.1 to 5 wt % of flavouring agent, more preferably of 0.2 to 3 wt %, even more preferably 0.5 to 2 wt % and
viii) preferably 0.2 to 7 wt % of starch, preferably non-chemically modified starch, more preferably physically modified starch, even more preferably physically modified potato starch.
